(19) United States
(12) Patent Application Publication
(10) Pub. No.: US 2009/0121585 A1
(43) Pub. Date: May 14, 2009

(54) THIN FILM TYPE INTEGRATED ENERGY HARVEST-STORAGE DEVICE

(75) Inventors: Young-Gi LEE, Daejeon-city (KR); Mangu KANG, Daejeon-city (KR); Sung Q. LEE, Daejeon-city (KR); Kang-Ho PARK, Daejeon-city (KR); Jongdae KIM, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-city (KR)

(21) Appl. No.: 12/039,087

(22) Filed: Feb. 28, 2008

(30) Foreign Application Priority Data
Aug. 17, 2007 (KR) 10-2007-0082932

(51) Int. Cl. H02N 2/18

(52) U.S. Cl. 310/319

(57) ABSTRACT

Provided is thin film type energy generation-storage device in which an energy generation device generating energy using a piezoelectric material and an energy storage device storing the generated energy are formed in a thin film type one unit.

### CROSS-REFERENCE TO RELATED PATENT APPLICATION

This application claims the benefit of Korean Patent Application No. 10-2007-0082932, filed on Aug. 17, 2007, in the Korean Intellectual Property Office, the disclosure of which is incorporated herein in its entirety by reference.

### BACKGROUND OF THE INVENTION

1. Field of the Invention

The present invention relates to a micro energy device, and more particularly, to a thin film type energy harvest-storage device.

The present invention was supported by the Information Technology (IT) New Growing Power Core Technique Development program of the Ministry of Information and Communication (MIC). [Project No.: 2006-S-006-02, project title: Ubiquitous Terminals].

2. Description of the Related Art

An energy generation device (energy-harvest device) forms alternating voltages in a piezoelectric material by causing vibration, bending, contracting, extending, etc in the piezoelectric material via sound waves, ultrasonic waves, or electromagnetic waves (refer to Korean Patent Nos. 10-0536919, 10-0554874, and 10-0561728), and the alternating voltages are emitted as alternating currents. However, such piezoelectric material currently used has a very low energy transformation efficiency and a very large size. Therefore, the piezoelectric material can be applied to air pressure monitoring systems or functional shoes, can be very limitedly used in ultra small sensors or bio devices. Also, since the energy generation device merely generates electric energy without having the possibility to store the generated energy, it is limitedly used in fields where a high power is instantly required or a stable power must be constantly supplied.

Recently, with the rapid developments of the microelectronic industry, micro-electromechanical systems (MEMS), in which very small electrical and mechanical parts are embedded in one unit, have received much attention. MEMS are expected to become one of the new industrial growth engines in the 21^{st} century and be applied in various information recording devices, small sensors, or medical instruments. However, due to their very small size, conventional bulk type batteries, such as lithium-ion batteries (LIB), cannot be used for MEMS. Thus, in order to put MEMS to practical use, microbatteries should also be developed.

Microbatteries are referred to as thin film batteries since they cannot be manufactured using a thick film method generally used for manufacturing conventional lithium-ion batteries. Thus, the microbatteries have to be manufactured using a thin film method. Research on thin film batteries was first conducted in early 1990s by Bates group of the Oak Ridge National Laboratory, U.S.A. (refer to Korean Patent Nos. 10-1998-0022956 and 10-2005-0001542, and U.S. Pat. Nos. 6,818,356B1 and 5,338,625). In the case of a conventional microbattery, if the thickness of an electrode is reduced to a μm level and the area is greatly reduced to a 1 cm² level, the capacity of the microbattery is reduced to a mAh level, and thus, the energy storing capacity is greatly reduced. In particular, in the case of a chargeable-type thin film battery, charging must be frequently repeated since the energy storing capacity is small. Thus, due to a low energy density and high manufacturing costs, thin film batteries have been hardly used as the main power source of MEMS.

However, as MEMS are miniaturized, the power devices should also be realized to embed, a micro or nano size. Thus, a new concept of a micro-storage type battery device having the size of a thin film battery and performance between that of a thin film battery and a thick film battery is required.

Recently, in many areas such as medical fields and information communication systems, micro-sensors such as implantable/built-in micro instruments, nanorobots, and smart dust devices, and techniques related to radio frequency identification (RFID) and ubiquitous sensor networks (USN) are expected to become future core industries. In relation to these industries, a new MEMS power device is strongly required. That is, there is a need to develop a completely independent embedded type micro power device that can be used semi-permanently, it is not necessary to replace it, and is remote and self rechargeable once mounted.

### SUMMARY OF THE INVENTION

The present invention provides a new type micro power device. That is, the present invention provides a new thin film type, semi-permanent, micro embedded energy generation-storage device by combining an energy generation device that uses sound waves/ultrasonic waves as the main energy source and a thin film type energy storage device, so that it is possible to increase the energy transformation efficiency of a piezoelectric device in the energy generation device.

In the present invention, an energy generation device that uses a piezoelectric material and an energy storage device that uses a battery (or an electric cell) are combined to form a one-body thin film type device that operates as a micro power energy device. The power generation efficiency of the energy generation device can be increased by using lead magnesium niobate-lead titanate (PMN-PT), lead zinc niobate-lead titanate (PZN-PT), or lead magnesium lithiumate-lead titanate (PML-PT) as a piezoelectric material that has high piezoelectric efficiency. In the case of the energy storage device, a thick film battery process is applied in a thin film battery process, and thus, the stability of battery is increased and manufacturing costs are reduced due to the simplified manufacturing process.

An energy generation-storage device according to the present invention has a single device configuration in which an energy generation device generating energy and an energy storage device storing generated energy are formed in one-body structure. Also, the energy generation-storage device can be manufactured in a size range from micrometers to centimeters, in various configurations such as a stacking type, a parallel type, or an array type through a MEMS process. Since the energy generation-storage device operating as a micro generator can generate energy and store the generated energy, it is expected that the energy generation-storage device will be applied to self-chargeable power devices for semi-permanent embedded type devices. For example, as a 3V-class micro power device, the energy generation-storage device can be used as a power device for a medical instrument that is implantable into an artificial joint, a muscle, or an artificial organ, or can be used as a semi-permanent mountable micro-sensor power device.

According to an aspect of the present invention, there is provided a thin film type energy generation-storage device comprising: an energy generation device that includes
a piezoelectric device having a piezoelectric material and electrodes connected to the piezoelectric material, and a direct current (DC) conversion circuit connected to the piezoelectric device; and an energy storage device connected to the energy generation device.

The energy generation device and the energy storage device may form a stacking structure or a parallel structure.

The DC conversion circuit may include a rectifier and a condenser.

The electrodes of the piezoelectric device may be formed on both opposite surfaces of the piezoelectric material, or on the same surface of the piezoelectric material.

The piezoelectric material may include a single crystal inorganic material, a poly crystal inorganic material, a polymer material, or a composite material of a polymer material and an inorganic material.

The single crystal inorganic material may include one or more selected from the group consisting of lead magnesium niobate-lead titanate (PMN-PT), lead zinc niobate-lead titanate (PZN-PT), and lead magnesium lithiumate-lead titanate (PML-PT). The poly crystal inorganic material may include lead zirconate titanate (PZT) or ZnO. The polymer material may be one selected from the group consisting of polytetrafluoroethylene, polyvinyledenefluoride, a copolymer of vinyledenefluoride and hexafluoropropylene, a copolymer of vinyledenefluoride and trifluoroethylene, a copolymer of vinyledenefluoride and tetrafluoroethylene, nation, flemion polymer, or a combination thereof. The composite material of a polymer and an inorganic material may be a film or fiber type material of a mixture of the single crystal inorganic material or the poly crystal inorganic material and the polymer material.

The energy storage device may include an anode layer, a cathode layer facing each other, and an electrolyte layer between the anode layer and the cathode layer.

The anode layer may include a transition metal oxide, a composite oxide of lithium and a transition metal, or a mixture thereof. The transition metal oxide may include lithium cobalt oxide, lithium mangan oxide, or vanadium oxide.

The cathode layer may include one selected from the group consisting of Li, silicon tin oxynitride, Cu, and a combination thereof.

The electrolyte layer may include a polymer electrolyte. The polymer electrolyte may include a polymer matrix, an inorganic additive, and an organic electrolyte solution having a salt. The polymer matrix may include one selected from the group consisting of polyethylene, polypropylene, polyimide, polysulfon, polyurethane, polyvinyl chloride, polystylene, polyethylene oxide, polypopylene oxide, polybutadiene, cellulose, carbolymethyl cellulose, nylon, polyacronitryl, polyvinyledenefluorid, polytetrafluoroethylene, a copolymer of vinyledenefluorid and hexafluoropropylene, a copolymer of vinyledenefluorid and trifluoroethylene, a copolymer of vinyledenefluorid and tetrafluoroethylene, polymethyl acrylate, polyethyl acrylate, polymethyl metacrylate, polyethyl metacrylate, polybutyl acrylate, polybutyl metacrylate, polyvinyl acetate, polyvinyl alcohol, starch, agar, and Nafion, a copolymer thereof, or a combination thereof. The inorganic additive may include at least one selected from the group consisting of silica, talc, alumina, titan oxide (TiO₂), clay, and zeloite. The organic electrolyte solution may include at least one selected from the group consisting of ethylene carbonate, propylene carbonate, dimethyl carbonate, diethyl carbonate, ethyl methyl carbonate, tetrahydrofuran, 2-methyl hydrofuran, dimethoxyethane, methyl formate, ethyl formate, and gamma-butyrolactone. The salt may include at least one lithium salt selected from the group consisting of LiClO₄, LiCF₃SO₃, LiPF₆, LiBF₄, and LiN(CF₃SO₂)₂.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a structure of an energy generation-storage device according to an embodiment of the present invention; and

FIG. 2 is a flow chart of a method of manufacturing an energy generation-storage device according to an embodiment of the present invention.

### DETAILED DESCRIPTION OF THE INVENTION

The present invention will now be described more fully with reference to the accompanying drawings in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity.

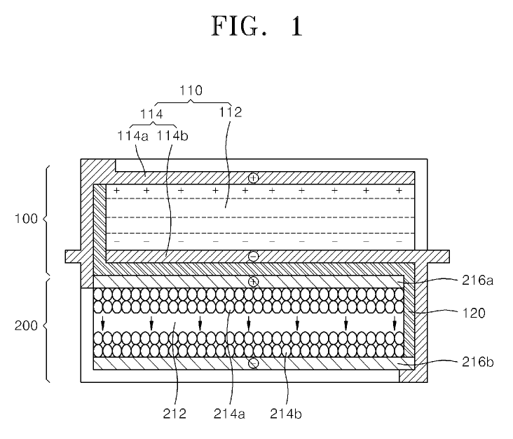

FIG. 1 is a schematic view of a structure of an energy generation-storage device according to an embodiment of the present invention.

Referring to FIG. 1, the energy generation-storage device includes an energy generation device 100 and an energy storage device 200. When sound waves or ultrasonic waves are applied to the energy generation device 100 from the outside, the energy generation device 100 generates energy due to a piezoelectric characteristic, and the generated energy is stored in the energy storage device 200. Thus, the energy generation device 100 performs as a wireless charge unit, and the energy storage device 200 performs as a main power source unit.

The energy generation device 100 includes a piezoelectric device 110 and a direct current (DC) conversion circuit 120. The piezoelectric device 110 includes a piezoelectric material 112 and electrodes 114a and 114b. The piezoelectric material 112 can be formed in a single layer or multiple layers. When the piezoelectric material 112 is formed in a multiple layers, the multiple layers can be formed of the same material or different materials. The electrodes 114a and 114b of the piezoelectric device 110 are respectively an anode 114a and a cathode 114b, and are electrically connected to the DC conversion circuit 120. The DC conversion circuit 120 converts an alternating current generated from the piezoelectric device 110 to a direct current. The DC conversion circuit 120 includes a rectifier and a condenser, can be formed in an insulating film, and is connected to the energy storage device 200. In FIG. 1, the anode 114a and the cathode 114b of the piezoelectric device 110 respectively contact two opposite surfaces of the piezoelectric material 112. However, the anode 114a and the cathode 114b of the piezoelectric device 110 can be alternately formed on the same surface of the piezoelectric material 112.

The energy storage device 200 can be formed in a thin film type battery (electric cell), for example, a lithium-ion thin film type battery. The term “thin film type battery” used herein refers to a battery having a thickness of several micrometers to several centimeters, that is, thinner than a thick film battery but thicker than a thin film battery, and having a performance close to that of a thick film battery. The energy storage device 200, which is thin film type battery, can include an anode layer 214a, a cathode layer 214b, and an electrolyte layer 212 between the anode layer 214a and the cathode layer 214b. The anode layer 214a and the cathode layer 214b formed on both opposite sides of the electrolyte layer 212 respectively contact current collecting layers 216a and 216b.

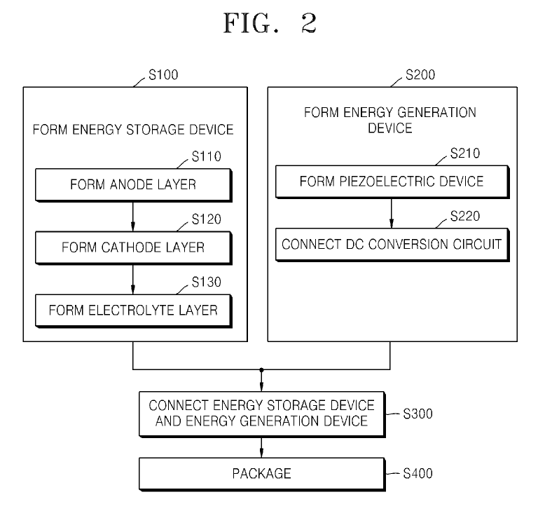

FIG. 2 is a flow chart of a method of manufacturing an energy generation-storage device according to an embodiment of the present invention.

Referring to FIG. 2, a method of forming the energy storage device (S100) will be described. An anode layer having a thickness of several tens of μm is formed on an anode current collecting layer (S110). The anode current collecting layer can be formed of Al, Pt, or Cu, etc., and the anode layer can be formed of a transition metal oxide such as lithium cobalt oxide, lithium mangan oxide, and vanadium oxide, a composite oxide of lithium and a transition metal, or a combination thereof. A cathode layer having a thickness of several tens of μm is formed on a cathode current collecting layer (S120). The cathode layer may include a material selected from the group consisting of Li, C, Si, and Sn, or a combination thereof. An isolation film is disposed between the cathode layer and the anode layer, a liquid electrolyte or inserting a film type polymer electrolyte is inserted into the cathode layer and the anode layer, thereby forming a micro energy storage device (S130).

The polymer electrolyte layer includes a polymer matrix, an inorganic additive and an organic electrolyte solution having a salt.

The polymer matrix may include one selected from the group consisting of polyethylene, polypropylene, polyimide, polysulfon, polyurethane, polyvinyl chloride, polystylene, polyethylene oxide, polypopylene oxide, polybutadiene, cellulose, carbolymethyl cellulose, nylon, polyacronitryl, polyvinyledenefluorid, polytetrafluoroethylene, a copolymer of vinyledenefluorid and hexafluoropropylene, a copolymer of vinyledenefluorid and trifluoroethylene, a copolymer of vinyledenefluorid and tetrafluoroethylene, polymethyl acrylate, polyethyl acrylate, polymethyl metacrylate, polyethyl metacrylate, polybutyl acrylate, polybutyl metacrylate, polyvinyl acetate, polyvinyl alcohol, starch, agar, and Nafion, a copolymer thereof, or a combination thereof.

The inorganic additive may include at least one selected from the group consisting of silica, talc, alumina, titan oxide (TiO₂), clay, and zeloite.

The electrolyte layer may include at least one selected from the group consisting of ethylene carbonate, propylene carbonate, dimethyl carbonate, diethyl carbonate, ethyl methyl carbonate, tetrahydrofuran, 2-methyl hydrofuran, dimethoxyethane, methyl formate, ethyl formate, and gamma-butyrolactone.

The salt may include at least one lithium salt selected from the group consisting of LiClO₄, LiCF₃SO₃, LiPF₆, LiBF₄, and LiN(CF₃SO₂)₂.

Next, a method of forming an energy generation device will be described (S200). First, a piezoelectric device is formed to manufacture the energy generation device (S210). The manufacture of the piezoelectric device is completed by forming electrodes in a piezoelectric material. The electrodes of the piezoelectric material may be formed on two opposite surfaces of the piezoelectric material with different polarities or may be formed on the same surface of the piezoelectric material. The electrode structure formed on the same surface of the piezoelectric material has a higher efficiency. A rectifier and a condenser are connected to the electrodes of the piezoelectric device (S220). The rectifier and the condenser constitute a DC conversion circuit that converts an alternating current generated from the piezoelectric device to a DC current. As the DC conversion circuit is connected to the piezoelectric device, the manufacture of the energy generation device is completed.

Next, the energy generation device and the energy storage device are connected through the rectifier and the condenser (S300). Finally, the energy generation-storage device is packaged (S400). Here, the energy generation-storage device may be packaged by stacking the energy generation device on the energy storage device and connecting them, or by attaching the energy generation device and the energy storage device on the same substrate parallel to each other.

The piezoelectric material of the energy generation device may include a single crystal inorganic material, a polycrystal inorganic material, a polymer material, or a composite material of a polymer and an inorganic material. The single crystal inorganic material may include lead magnesium niobate-lead titanate (PMN-PT), lead zinc niobate-lead titanate (PZN-PT), or lead magnesium lithiumate-lead titanate (PML-PT). The polycrystal inorganic material may include PZT (PbZrTiO) or ZnO. The polymer material may include polytetrafluoroethylene, polyvinyledenefluorid, a copolymer of vinyledenefluorid and hexafluoropropylene, a copolymer of vinyledenefluorid and trifluoroethylene, a copolymer of vinyledenefluorid and tetrafluoroethylene, nafion, flemion polymer, or a combination thereof. In the case of the composite material of a polymer and an inorganic material, a film or fiber type material manufactured through mixing a single crystal or a polycrystal inorganic material with a polymer material may be used. The piezoelectric materials have high energy conversion efficiency, and thus, can increase the efficiency of the energy generation device.

The forming the energy storage device (S100) can precede the forming the energy generation device (S200) according to the embodiment described above, or vice versa.

The method of manufacturing a thin film type energy storage device according to an embodiment of the present will now be described in detail with respect to the following non-limitative experimental examples.

### EXAMPLE 1

A lithium cobalt oxide (LiCoO₂) layer as an anode layer is formed on an anode current collecting layer. The anode layer is formed to have a thickness of approximately 30 μm and an area of 1 cm×1 cm. A cathode layer formed of carbon having a thickness of approximately 30 μm and an area of 1 cm×1 cm is formed on a cathode collecting layer. A film type polymer electrolyte is inserted between the anode layer and the cathode layer and is packaged in a pouch, and thus, the manufacture of a thin film type battery which is an energy storage device is completed.

PMN-PT single crystal thin film, a piezoelectric material, is attached to a silicon wafer using epoxy, and the piezoelectric material is patterned to have a thickness of 10 μm with an area of 1 cm×1 cm. The patterning may be performed using a plasma etching process such as inductively coupled plasma. Next, a piezoelectric device is formed by forming interdigitated electrodes on a surface of the PMN-PT using a lift-off method. The interdigitated electrodes denote a plurality of cylindrical or hexagonal electrodes disposed in a three-dimensional matrix shape. Here, anodes and cathodes can be alternately disposed close to each other. The piezoelectric device that includes the piezoelectric material and the electrodes is connected to a rectifier and a condenser, and then, the resultant product is attached on a thin film battery. As a result, the energy generation device is disposed on the energy storage device. The rectifier and the condenser of the energy generation device are disposed on a portion of the energy generation device to be connected to the energy storage device. In this manner, an one-body type energy generation-storage device having an area of 1 cm×1 cm with a thickness of 150 μm, an energy conversion efficiency of 5% or more, an output density of 0.05 mW/mm³ or more, and an anode capacity of 0.3 mAh/mm³ or more is configured. A final terminal can be attached to the energy storage device.

### EXAMPLE 2

PMN-PT single crystal thin film is attached to a silicon substrate having an area of 2 cm×1 cm using epoxy, the PMN-PT is patterned to have a thickness of 10 μm with an area of 1 cm×1 cm. The patterning may be performed using a plasma etching process. Next, interdigitated electrodes are formed on a surface of the PMN-PT using a lift-off method. The single crystal thin film is connected to a DC conversion circuit that includes a rectifier and a condenser to complete the manufacture of an energy generation device.

The thin film battery having an area of 1 cm×1 cm manufactured as the same method as in the embodiment 1 is disposed on the silicon substrate parallel to the energy generation device which is formed on the silicon substrate. Finally, an energy generation-storage device having an area of 2 cm×1 cm with a thickness of 150 μm is configured. A final terminal can be attached to the energy storage device.

### EXAMPLE 3

An energy generation-storage device can be manufactured by the same method as in Examples 1 and 2 using vanadium oxide having a thickness of approximately 30 μm as an anode instead of LiCoO₂.

### EXAMPLE 4

An energy generation-storage device can be manufactured by the same method as in Examples 1 and 2 using lithium manganese oxide having a thickness of approximately 30 μm as an anode instead of LiCoO₂.

### EXAMPLE 5

In the energy storage device, the anode is formed of LiCoO₂ having a three-dimensional cylindrical shape structure and a thickness of approximately 30 μm, and the cathode is formed of silicon-tin oxide also having a three-dimensional cylindrical shape structure and a thickness of approximately 30 μm. The other portions can be formed as in Example 1, and thus, an energy generation-storage device is manufactured.

### EXAMPLE 6

The anode is formed of LiCoO₂ having a three-dimensional cylindrical shape structure and a thickness of approximately 30 μm, and the cathode is formed of silicon-tin oxide also having a three-dimensional cylindrical shape structure and a thickness of approximately 30 μm. A high viscosity solution made by melting a plasticized polymer electrolyte (20 weight % polyvinyledenefluoride, 5 weight % silica, and 75 weight % liquid electrolyte: 1 M LiPF₆ in EC/DMC) in acetone solvent is injected between the anode and the cathode. The other portions can be formed as in Example 1, and thus, an energy generation-storage device is manufactured.

### EXAMPLE 7

The piezoelectric material of the energy generation device is formed of PZN-PT, PZT, or ZnO having a thickness of several tens of μm or less instead of PMN-PT. The rest portions can be formed as in the Example 2, and thus, an energy generation-storage device is manufactured.

### EXAMPLE 8

The piezoelectric material of the energy generation device is formed of polyvinyledenefluoride film lamination (10 of polyvinyledenefluoride sheets are combined) having a thickness of several tens of μm. The other portions can be formed as in Example 2, and thus, an energy generation-storage device is manufactured.

### EXAMPLE 9

The piezoelectric material of the energy generation device is formed of a polyvinyledenefluoride/PZT (70 weight %/30 weight %) composite film having a thickness of several tens of μm. The rest portions can be formed as in Example 2, and thus, an energy generation-storage device is manufactured.

As described above, the thin film type energy generation-storage device according to the present invention has a single device configuration in which an energy generation device generating energy and an energy storage device storing generated energy are formed in one-body structure. The thin film type energy generation-storage device can be manufactured in a size range from micrometers to centimeters, in various configurations such as a stacking type, a parallel type, or an array type using a MEMS process. Since the thin film type energy generation-storage device as a micro generator can generate power by wireless charging via sound waves/ultrasonic waves and can store the generated energy, the thin film energy generation-storage device can be used as a self-chargeable power device for semi-permanent imbedded type devices. For example, as a 3V-class micro power device, the thin film type energy generation-storage device can be used as a power device for a medical instrument that is implantable into an artificial joint, a muscle, or an artificial organ, and can be used as a semi-permanent mountable micro-sensor power device.

The energy generation device according to the present invention includes a piezoelectric material such as PZN-PT that has high sensitivity with respect to sound waves or ultrasonic waves, thereby increasing energy conversion efficiency.

For the energy storage device, the reaction surface of electrodes is increased by inducing interdigitated electrodes having a three-dimensional structure. Thus, the capacity usage rate is increased, and mass production of low cost energy storage devices is possible by using an improved conventional electrolyte process instead of a conventional complicated LIPON deposition process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A thin film type energy generation-storage device comprising:
an energy generation device that comprises a piezoelectric device having a piezoelectric material and electrodes connected to the piezoelectric material, and a direct current (DC) conversion circuit connected to the piezoelectric device; and
an energy storage device connected to the energy generation device.

2. The thin film type energy generation-storage device of claim 1, wherein the energy generation device and the energy storage device form a stacking structure or a parallel structure.

3. The thin film type energy generation-storage device of claim 1, wherein the DC conversion circuit comprises a rectifier and a condenser.

4. The thin film type energy generation-storage device of claim 1, wherein the electrodes of the piezoelectric device are respectively formed on both opposite surfaces of the piezoelectric material.

5. The thin film type energy generation-storage device of claim 1, wherein the electrodes of the piezoelectric device are formed on the same surface of the piezoelectric material.

6. The thin film type energy generation-storage device of claim 1, wherein the piezoelectric material comprises a single crystal inorganic material, a poly crystal inorganic material, a polymer material, or a composite material of a polymer material and an inorganic material.

7. The thin film type energy generation-storage device of claim 6, wherein the single crystal inorganic material comprises one or more selected from the group consisting of lead magnesium niobate-lead titanate (PMN-PT), lead zinc niobate-lead titanate (PZN-PT), and lead magnesium lithiumate-lead titanate (PML-PT).

8. The thin film type energy generation-storage device of claim 6, wherein the poly crystal inorganic material comprises lead zirconate titanate (PZT) or ZnO.

9. The thin film type energy generation-storage device of claim 6, wherein the polymer material is one selected from the group consisting of polytetrafluoroethylene, polyvinyledenefluoride, a copolymer of vinyledenefluoride and hexafluoropropylene, a copolymer of vinyledenefluoride and trifluoroethylene, a copolymer of vinyledenefluoride and tetrafluoroethylene, nation, flemion polymer, or a combination thereof.

10. The thin film type energy generation-storage device of claim 6, wherein the composite material of a polymer and an inorganic material is a film or fiber type material of a combination of the single crystal inorganic material or the poly crystal inorganic material and the polymer material.

11. The thin film type energy generation-storage device of claim 1, wherein the energy storage device comprises an anode layer, a cathode layer facing the anode layer, and an electrolyte layer between the anode layer and the cathode layer.

12. The thin film type energy generation-storage device of claim 11, wherein the anode layer comprises a transition metal oxide, a composite oxide of lithium and a transition metal, or a mixture thereof.

13. The thin film type energy generation-storage device of claim 12, wherein the transition metal oxide comprises lithium cobalt oxide, lithium manganese oxide, or vanadium oxide.

14. The thin film type energy generation-storage device of claim 11, wherein the cathode layer comprises one selected from the group consisting of Li, silicon tin oxynitride, Cu, and a mixture thereof.

15. The thin film type energy generation-storage device of claim 11, wherein the electrolyte layer comprises a polymer electrolyte.

16. The thin film type energy generation-storage device of claim 15, wherein the polymer electrolyte comprises a polymer matrix, an inorganic additive, and an organic electrolyte solution having a salt.

17. The thin film type energy generation-storage device of claim 16, wherein the polymer matrix comprises one selected from the group consisting of polyethylene, polypropylene, polyimide, polysulfon, polyurethane, polyvinyl chloride, polystylene, polyethylene oxide, polypopylene oxide, polybutadiene, cellulose, carbolymethyl cellulose, nylon, polyacronitryl, polyvinyledenefluorid, polytetrafluoroethylene, a copolymer of vinyledenefluorid and hexafluoropropylene, a copolymer of vinyledenefluorid and trifluoroethylene, a copolymer of vinyledenefluorid and tetrafluoroethylene, polymethyl acrylate, polyethyl acrylate, polymethyl metacrylate, polyethyl metacrylate, polybutyl acrylate, polybutyl metacrylate, polyvinyl acetate, polyvinyl alcohol, starch, agar, and Nafion, a copolymer thereof, or a combination thereof.

18. The thin film type energy generation-storage device of claim 16, wherein the inorganic additive comprises at least one selected from the group consisting of silica, talc, alumina, titan oxide (TiO₂), clay, and zeloite.

19. The thin film type energy generation-storage device of claim 16, wherein the organic electrolyte solution comprises at least one selected from the group consisting of ethylene carbonate, propylene carbonate, dimethyl carbonate, diethyl carbonate, ethyl methyl carbonate, tetrahydrofuran, 2-methyl hydrofuran, dimethoxyethane, methyl formate, ethyl formate, and gamma-butyrolactone.

20. The thin film type energy generation-storage device of claim 16, wherein the salt comprises at least one lithium salt selected from the group consisting of LiClO₄, LiCF₃SO₃, LiPF₆, LiBF₄, and LiN(CF₃SO₂)₂.
